(19) United States
(12) Patent Application Publication
(10) Pub. No.: US 2007/0239452 A1
(43) Pub. Date: Oct. 11, 2007

(54) Targeting of buzz advertising information

(76) Inventors: Anand Madhavan, Sunnyvale, CA (US); Kashyap Lodhiya, Sunnyvale, CA (US)

Correspondence Address: Stattler-Suh PC, 60 SOUTH MARKET, SUITE 480, SAN JOSE, CA, 95113, US

(21) Appl. No.: 11/394,819

(22) Filed: Mar. 31, 2006

(51) Int. Cl. G10L 15/00

(52) U.S. Cl. 704/252

(57) ABSTRACT

A system and method to facilitate targeting of advertising based on buzz-related information in a network, wherein users access an entity through the network, such as the Internet, and request content from the entity or initiate other events based on various topics of interest at the time of each event. These topics of interests, also referred to as buzz data, are aggregated over time as temporal interests for certain categories. The buzz data corresponding to one or more relevant topics of interest for a majority of users is stored and updated continuously. Subsequent to receipt of the request for content from a user, the requested content and buzz advertising information related to selected buzz data are retrieved, the buzz advertising information being targeted to the user viewing the page or the requested content based on one or more predetermined parameters associated with the user or the content. Finally, the retrieved content and buzz advertising information are displayed to the user.

### TECHNICAL FIELD

The present invention relates generally to the field of network-based communications and, more particularly, to a system and method to facilitate targeting of advertising based on buzz-related information in a network, such as the Internet.

### BACKGROUND OF THE INVENTION

The explosive growth of the Internet as a publication and interactive communication platform has created an electronic environment that is changing the way business is transacted. As the Internet becomes increasingly accessible around the world, users need efficient tools to navigate the Internet and to find content available on various websites.

In a typical content management system, users make requests for content, or search queries, such as, for example, published data available at various websites, or simply request a web page view by clicking on a link with a conventional mouse click command. The users subsequently receive the requested content and additional content that may or may not be relevant to the requested content or to the specific user, such as, for example, advertising content associated with advertising entities having a presence on the Internet.

The large number of transactions and communications performed over the Internet has lead to the development of techniques for data gathering and processing to determine topics of interest requested by a majority of users in a predetermined period of time, such as, for example, hourly, daily, monthly, yearly, continuously, or any other convenient predetermined periods of time. This information is subsequently used to provide each user with advertising content related to the specific topics or categories of interest. What is needed now is a method and system to facilitate targeting of such topic-related advertising information over a network based on a predetermined set of content and/or user-related parameters in order to ensure successful targeted advertising campaigns.

### SUMMARY OF THE INVENTION

A system and method to facilitate targeting of advertising based on buzz-related information in a network are described. Users access an entity via a network, such as the Internet, and request content from the entity or initiate other events based on various topics of interest at the time of each event. These topics of interests, also referred to as buzz data, are aggregated over time as temporal interests for certain categories. The buzz data corresponding to one or more relevant topics of interest for a majority of users is stored and updated continuously. Subsequent to receipt of the request for content from a user, the requested content and buzz advertising information related to selected buzz data are retrieved, the buzz advertising information being targeted to the user viewing the page or the requested content based on one or more predetermined parameters associated with the user or the content. Finally, the retrieved content and buzz advertising information are displayed to the user.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a block diagram illustrating an exemplary network-based entity, which facilitates targeting of buzz advertising information, according to one embodiment of the invention;

FIG. 2 is a flow diagram illustrating a method to facilitate targeting of buzz advertising information within the network-based entity, according to one embodiment of the invention;

FIG. 3 is a block diagram illustrating the interaction between the network-based entity and a client machine associated with a user, according to one embodiment of the invention;

FIG. 4 is a block diagram illustrating an exemplary database, which at least partially implements and supports the network-based entity, according to one embodiment of the invention;

FIG. 5 is a flow diagram illustrating a method to facilitate retrieval of the buzz advertising information, according to one embodiment of the invention;

FIG. 6 is a flow diagram illustrating a method to facilitate retrieval of the buzz advertising information, according to an alternate embodiment of the invention;

FIG. 7 is a flow diagram illustrating a method to facilitate retrieval of the buzz advertising information, according to another alternate embodiment of the invention;

FIG. 8 is a diagrammatic representation of a machine in the exemplary form of a computer system within which a set of instructions may be executed.

### DETAILED DESCRIPTION

In embodiments described in detail below, users access an entity, such as, for example, a web portal, via a network, such as the Internet, and request content from the entity or initiate other events, such as, for example, a search query, a search link click, an ad view, an ad click, or any other known interactive events, based on various topics of interest at the time of each event. Data is collected and processed over time to obtain buzz data, which indicates relevant topics of interest for a majority of users. Buzz data is further stored and is updated continuously at predetermined periods of time, such as, for example, hourly, daily, monthly, yearly, continuously, or any other convenient predetermined periods of time.

In one embodiment, the user transmits a search query to the entity and requests content related to the search query. The entity retrieves the requested content and buzz advertising information related to selected buzz data associated with query terms contained in the search query and displays the retrieved content and buzz advertising information for the user. In an alternate embodiment, the user requests a context-specific web page, such as, for example, a music-related web page. The entity retrieves the web page and buzz advertising information related to selected buzz data associated with a page category corresponding to the requested web page, such as, for example, a music category, and displays the web page and the buzz advertising information for the user. In another alternate embodiment, if the requested page is a generic web page, the entity retrieves the web page and buzz advertising information related to selected buzz data associated with a user profile stored in connection with the user and displays the web page and the buzz advertising information for the user. In yet another alternate embodiment, the entity transmits the buzz data to selected advertising entities to suggest related buzz advertising information that may interest the users, related buzz keywords that advertisers may bid on, or which graphical advertisements to show to the users.

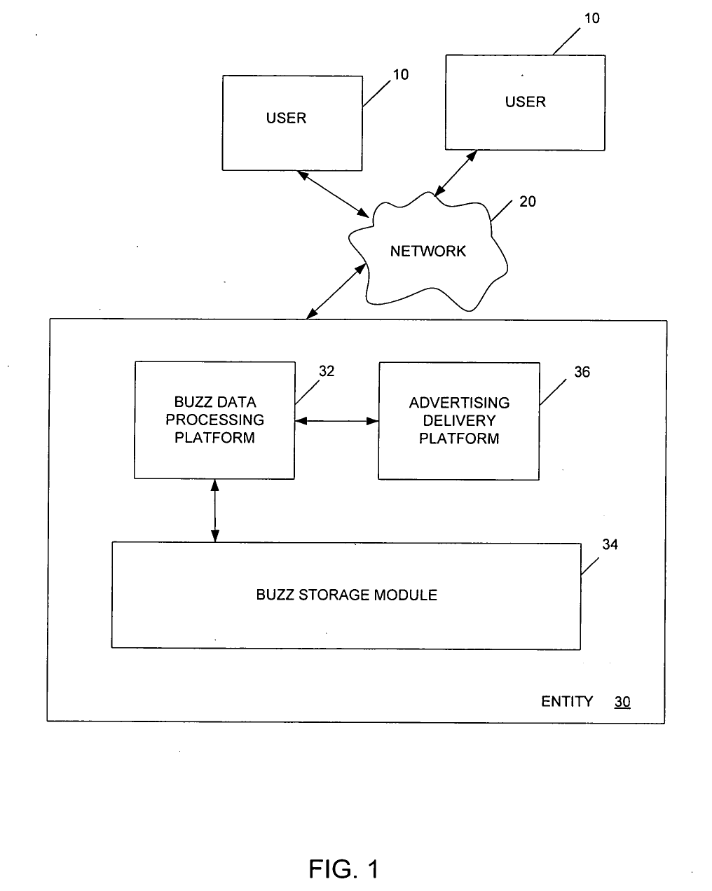

FIG. 1 is a block diagram illustrating an exemplary network-based entity, which facilitates targeting of buzz advertising information. As illustrated in FIG. 1, multiple users 10 interact with the entity 30 through a network 20, such as, for example, the Internet. The users 10 access the entity 30 to request display of specific web pages, to perform search queries and view search results, to communicate with other users 10 through automated communication means, and/or to request content information stored within the entity 30 or accessible through the entity 30.

In one embodiment, the entity 30 further includes a buzz data processing platform 32 to process and determine buzz information, such as, for example, buzz keywords corresponding to current topics of interest collected continuously, and to store the buzz keywords in a buzz storage module 34 coupled to the buzz data processing platform 32, as described in further detail below.

In addition, the entity 30 further includes an advertising delivery platform 36 coupled to the buzz data processing platform 32. The advertising delivery platform 36 retrieves the buzz keywords from the buzz storage module 34 via the buzz data processing platform 32 and facilitates display of advertising content related to the buzz keywords for the users 10, as described in further detail below.

In one embodiment, the buzz data processing platform 32 processes events logged by the entity 30 in a predetermined period of time, such as, for example, a previous 24-hour period. Examples of such events may include search queries initiated by the users 10, which are collected in search logs within the entity 30, web pages viewed, ads viewed, ads clicked, search clicks, or other events initiated by the users 10 within the previous predetermined period of time, which are recorded and analyzed to retrieve temporally popular context information associated with each subsequent web page view, and other such events generated for or initiated by the users 10 of the entity 30. The resulting processed data indicates specific information about the users' interests at the time of each event and is used in determining current topics of interest for a majority of the users 10.

In one embodiment, buzz data processing starts with data collection. The buzz data processing platform 32 retrieves data from the search logs, such as, for example, logs containing searches initiated by the users 10, searches performed by the entity 30 or one of its component entities, and/or other search events that happened within the predetermined period of time. Furthermore, the buzz data processing platform 32 retrieves data related to the web page views associated with the users 10, such as, for example, web pages displayed for the users 10, or additional information about the click-through-rate of any links displayed for the users 10.

Next, the buzz data processing platform 32 categorizes the retrieved data into predetermined categories based on buzz keywords, which represent terms related to various topics of interest search or viewed by the users 10. In one example, if a user 10 is searching for a performer associated with a music event, buzz keywords such as the performer's name, or a song title are categorized within a music category. Subsequently, the buzz data processing platform 32 performs a canonicalization procedure, whereby similar categorized buzz keywords are merged together based on a set of predetermined rules. In one example, for every buzz keyword, such as the performer's name, if a number of unique users 10 searching for the buzz keyword is above a certain threshold value, the buzz keyword is considered for the canonicalization procedure.

Finally, the buzz keywords and the associated categories are aggregated based on user characteristics, such as, for example, age, gender, and/or location of the particular user 10. At the same time, keywords and categories without significant user data are filtered out of the final buzz results. Although the embodiment described above enables the processing platform 32 to gather and process buzz data, it is to be understood that other methods of data gathering and processing may be used to obtain the buzz keywords.

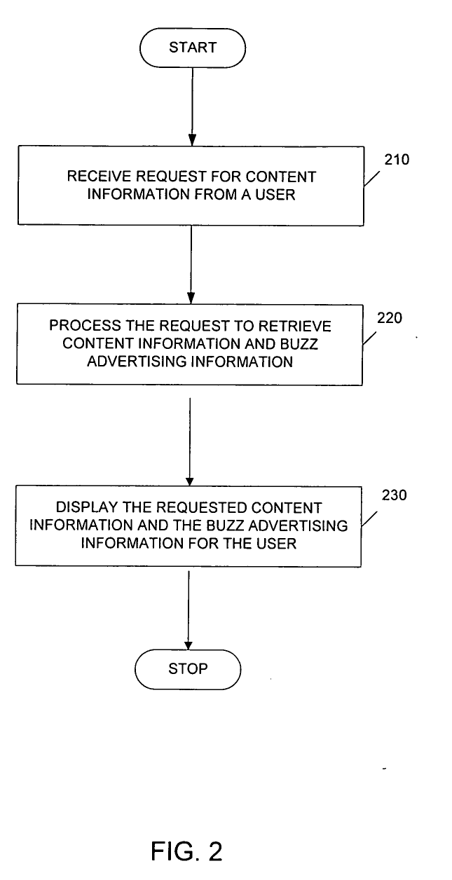

FIG. 2 is a flow diagram illustrating a method to facilitate targeting of buzz advertising information within the network-based entity. As shown in FIG. 2, at processing block 210, a request for content information is received from a user 10. In one embodiment, the user 10 transmits a request for content information, such as, for example, a request to view a specific web page, or a search request to retrieve content information, to the entity 30. The entity 30 receives the request for content information from the user 10 through the network 20.

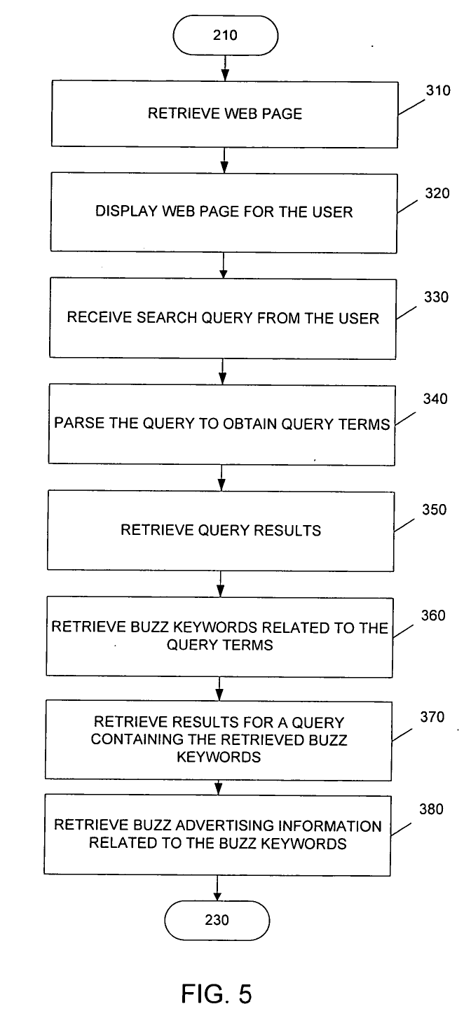

At processing block 220, the request is processed to retrieve the content information and buzz advertising information. In one embodiment, the entity 30 processes the request to retrieve content information. In addition, the entity 30 retrieves buzz advertising information corresponding to the specific request or related to the specific user 10, as described in further detail below in connection with FIGS. 5-7.

Finally, at processing block 230, the requested content information and related buzz advertising information are displayed for the user. In one embodiment, the entity 30 transmits the requested content information and related buzz advertising information via the network 20 to be displayed to the user 10 in various formats, such as, for example, graphics, flash, image, video, text link, and other known formats. The buzz advertising information may thus be presented to the user as banner advertisements, flash advertisements, text links, shared-content advertisements, and/or any other advertising display formats.

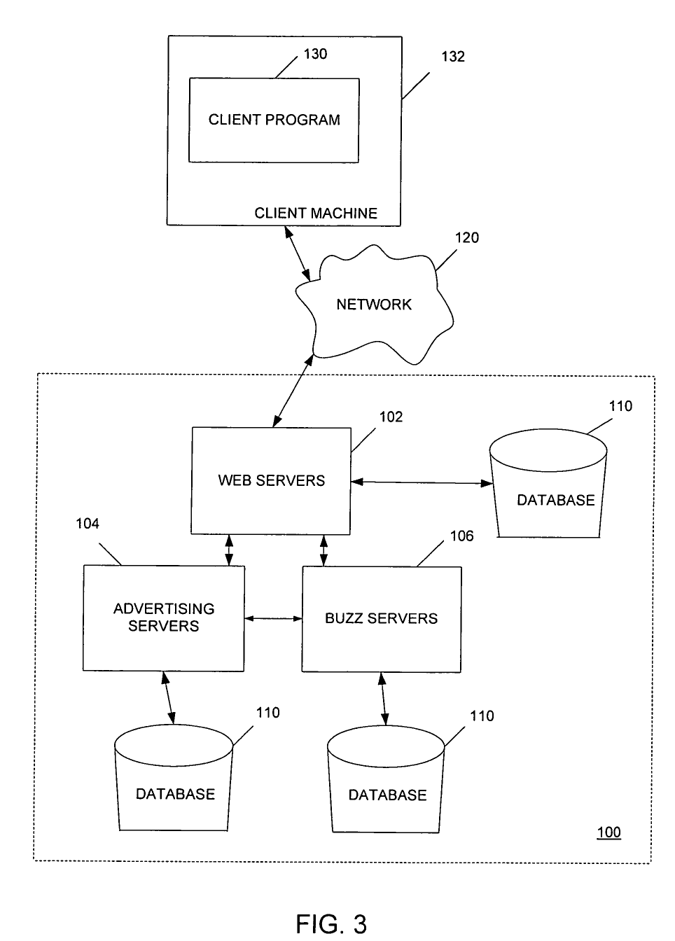

FIG. 3 is a block diagram illustrating the interaction between the network-based entity and a client machine associated with a user, according to one embodiment of the invention. While an exemplary embodiment of the present invention is described within the context of an entity 100 enabling targeting of buzz advertising information to the client machine 132 associated with a user, it will be appreciated by those skilled in the art that the invention will find application in many different types of computer-based, and network-based, entities, such as, for example, commerce entities, content portal entities, or other known entities having a presence on the network.

In one embodiment, a network-based entity 100 includes one or more front-end web servers 102, which may, for example, deliver web pages to multiple users, such as the users 10 shown in FIG. 1, (e.g., markup language documents), handle search queries to the entity 100, provide automated communications to/from users of the entity 100, deliver images to be displayed within the web pages, deliver content information to the users, and other processing servers, which provide an intelligent interface to the back-end of the entity 100.

The entity 100 further includes one or more back-end servers, for example, advertising servers 104 and buzz servers 106, each of which maintaining and facilitating access to one or more respective databases 110. The entity 100 may further include one or more database servers (not shown) configured to maintain the functionality of all databases 110 and to enable data sharing among the various databases within the entity 100.

In one embodiment, the web servers 102 are coupled to a respective database 110, which stores, for example, user information and/or content information related to the users of the entity 100, as described in further detail below. The advertising servers 104, which may or may not be a part of the advertising delivery platform 36 shown in FIG. 1, are coupled to a corresponding database 110 and are configured to select and transmit advertising content, such as, for example, advertisements, sponsor links, integrated links, and other types of advertising content, to users via the network 120, as described in further detail below. The buzz servers 106, which may or may not be a part of the buzz data processing platform 32 shown in FIG. 1, are also coupled to a respective database 110 and are configured to process buzz data to obtain associated buzz keywords and to store the buzz keywords in corresponding tables within the database 110. In an alternate embodiment, the web servers 102, the advertising servers 104, and the buzz servers 106 are coupled to a single database 110, such as, for example, the buzz storage module 34 shown in FIG. 1, which at least partially implements and supports the network-based entity 100.

The network-based entity 100 may be accessed by a client program 130, such as a browser (e.g., the Internet Explorer browser distributed by Microsoft Corporation of Redmond, Wash.) that executes on a client machine 132 and accesses the facility 100 via a network 120, such as, for example, the Internet. Other examples of networks that a client may utilize to access the facility 100 includes a wide area network (WAN), a local area network (LAN), a wireless network (e.g., a cellular network), the Plain Old Telephone Service (POTS) network, or other known networks.

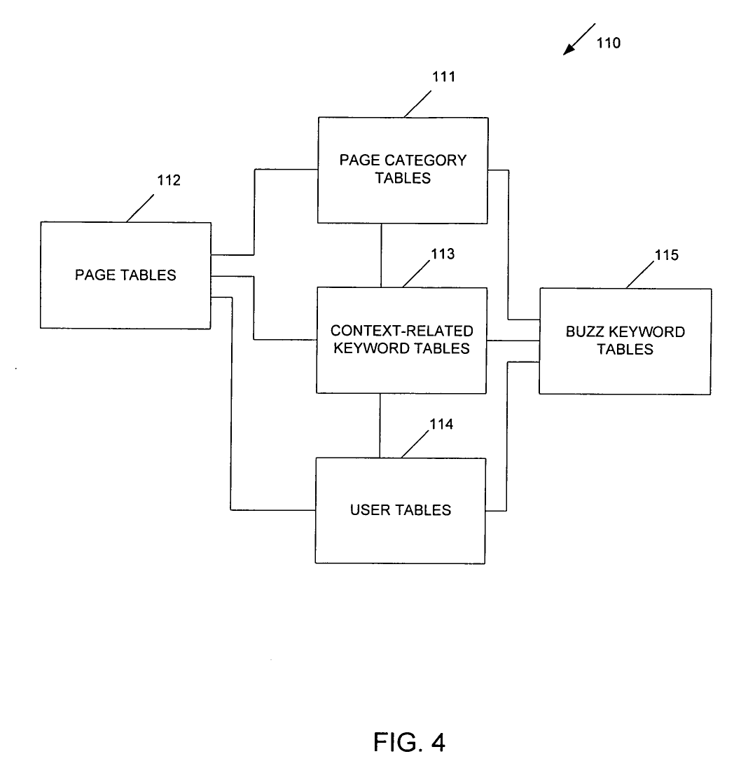

FIG. 4 is a block diagram illustrating an exemplary database 110, which at least partially implements and supports the network-based entity 100, according to one embodiment of the invention. In one embodiment, the databases 110 shown in FIG. 3 may be implemented as one relational database, and may include a number of tables having entries, or records, that are linked by indices and keys. Alternatively, the databases 110 may be implemented as collection of objects in an object-oriented database, a distributed database, or any other databases.

As illustrated in FIG. 4, in one embodiment, the exemplary database 110 includes multiple tables, of which tables specifically provided to enable an exemplary embodiment of the invention, namely page category tables 111, page tables 112, context-related keyword tables 113, user tables 114, and buzz keyword tables 115, are shown.

In one embodiment, the page category tables 111 may contain, for example, multiple categories used to group the web pages accessed by the entity 100 and/or by the user 10, the page tables 112 store web page information related to the web pages, and the context-related keyword tables 113 may contain, for example, keywords contextually related to each specific page category. In one embodiment, editors associated with the entity 100 enter the keywords in the tables 113 of the database 110. Alternatively, the keywords may be stored algorithmically. For example, a “MUSIC” page category stored within the tables 111 may be linked to various music-related web pages stored within the tables 112 and may also be linked to multiple keywords stored within the tables 113, such as, for example, “album,” “CD,” “DVD,” “song,” and other similar terms.

In one embodiment, the user tables 114 contain a record for each user of the entity 100, such as, for example, a user profile containing user data which may be linked to multiple items stored in the other tables 111, 112, 113 within the database 110, such as, for example, user identification information, user account information, and other known data related to each user. The user identification information may further include a user profile containing demographic data about the user, geographic data detailing user access locations, behavioral data related to the user, such behavioral data being generated by a behavioral targeting system, which analyzes user activities in connection with the entity 100, and other identification information related to each specific user. In one embodiment, the stored data may also include near short term behavior of the user, or, in the alternative, long term behavior of the user or an algorithmic combination of short term and long term behavior of the user.

In one embodiment, the buzz keyword tables 115 store multiple keywords representing the current topics of interest for a majority of users, which are compiled on a continuous basis from events representing current user activities while accessing the entity 100. The buzz keywords can either be stored on a per category basis or individually.

It is to be understood that the database 110 may include any of a number of additional tables, which may also be shown to be linked to the page category tables 111, the page tables 112, and the context-related keyword tables 113, such as, for example, content tables, which store content information related to the web pages. Similarly, the database 110 may also include multiple tables storing content information, which enable functionality of the advertising servers 104 and the buzz servers 106 within the entity 100.

FIG. 5 is a flow diagram illustrating one embodiment for a method to facilitate retrieval of the buzz advertising information. As shown in FIG. 5, subsequent to the receipt of the request for content information, at processing block 310, a web page is retrieved. In one embodiment, the web servers 102 receive the request for content information from the user through the network 120 and retrieve a corresponding web page from the page tables 112 of the respective database 110 coupled to the web servers 102. In one embodiment, the requested web page is a search page containing fields, which enable the user to enter and transmit a search query to the entity 100.

At processing block 320, the web page is displayed for the user. In one embodiment, the web servers 102 transmit the retrieved web page to the client machine 132 via the network 120 for subsequent display in the client program 130.

At processing block 330, a search query is received from the user. In one embodiment, the user enters a search query in the displayed web page and transmits the query to the web servers 102 within the entity 100 via the client machine 132 and the network 120.

At processing block 340, the query is parsed to obtain one or more query terms. In one embodiment, the web servers 102 receive the query from the user and parse the query to obtain relevant query terms.

At processing block 350, query results are retrieved for the received query. In one embodiment, the web servers 102 access the database 110 and retrieve the query results associated with the original query.

At processing block 360, buzz keywords related to the parsed query terms are retrieved from the database 110. In one embodiment, the web servers 102 communicate with the buzz servers 106 and transmit the query terms to the buzz servers 106. The buzz servers 106 access corresponding buzz keyword tables 115 within the respective database 110 and retrieve buzz keywords or categories related to the parsed query terms.

At processing block 370, query results for a query containing the retrieved buzz keywords are retrieved from the database 110. In one embodiment, the web servers 102 receive the buzz keywords from the buzz servers 106 and form a query containing the retrieved buzz keywords. Subsequently, the web servers 102 access the database 110 to retrieve query results for the newly formed query. In an alternate embodiment, the buzz keywords are received and then forwarded directly to the advertising servers 104 at processing block 380, where buzz advertising information related to the buzz keywords is retrieved. In one embodiment, the web servers 102 communicate with the advertising servers 104 and transmit the retrieved buzz keywords to the advertising servers 104. Subsequently, the advertising servers 104 access the respective database 110 to retrieve buzz advertising information related to the buzz keywords.

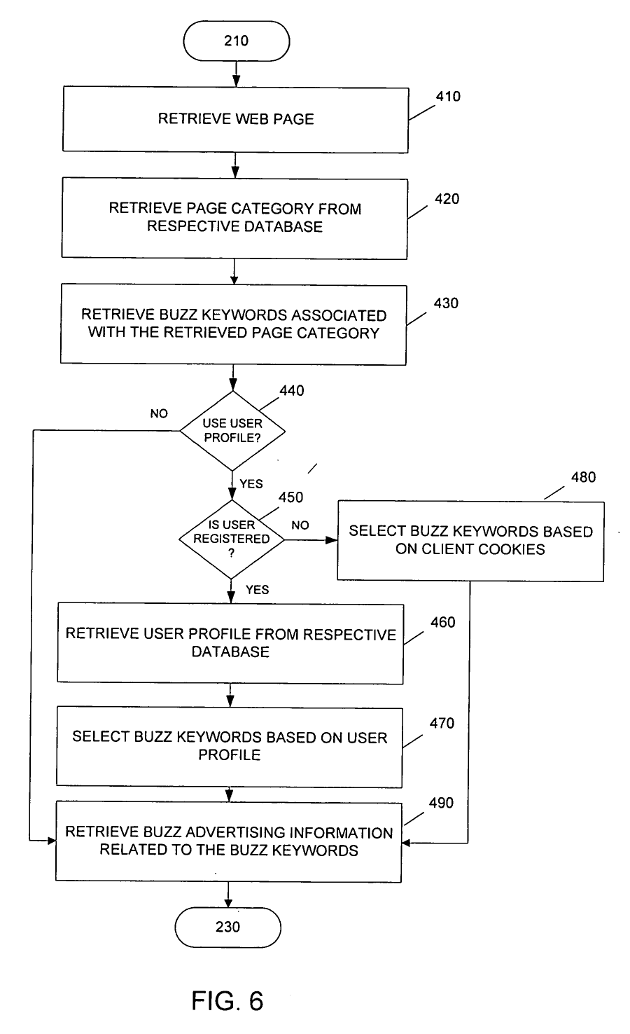

FIG. 6 is a flow diagram illustrating an alternate embodiment for the method to facilitate retrieval of the buzz advertising information. As shown in FIG. 6, subsequent to the receipt of the request for content information, at processing block 410, a web page is retrieved. In one embodiment, the web servers 102 receive the request for content information from the user through the network 120 and retrieve a corresponding web page from the page tables 112 of the respective database 110 coupled to the web servers 102. In one embodiment, the requested web page is a context-specific page, such as, for example, a music-related web page. The web servers 102 review the web page requested by the user to determine if the page refers to specific content material and belongs to a corresponding category stored in the page category tables 111.

At processing block 420, a page category corresponding to the content material existent on the page is retrieved. In one embodiment, the web servers 102 access the page category tables 111 within the database 110 to retrieve the corresponding page category.

At processing block 430, buzz keywords corresponding to the page category are retrieved. In one embodiment, the web servers 102 communicate with the buzz servers 106 and transmit the page category to the buzz servers 106. The buzz servers 106 access the corresponding buzz keyword tables 115 within the database 110 and retrieve buzz keywords related to the page category.

At processing block 440, a decision is made whether to use a user profile stored within the user tables 114 in addition to the retrieved page category. If no user profile is used, then the procedure jumps to processing block 490 described in detail below.

Otherwise, if the decision is made to use the profile associated with the user, at processing block 450, another decision is made whether the user requesting the retrieved page is registered with the entity 100. In one embodiment, the web servers 102 access the user tables 114 within the database 110 to determine whether the user tables 114 contain a record associated with the specific user or any other user information.

If the user is not registered with the entity 100, then at processing block 480, buzz keywords corresponding to user identification parameters, such as, for example, client cookies stored on the client machine 132, are selected. In one embodiment, the web servers 102 communicate with the buzz servers 106 and transmit one or more user identification parameters to the buzz servers 106, such as, for example, any client cookies residing on the client machine 132 or any other user identification information. The buzz servers 106 then select buzz keywords related to the user identification parameters. The procedure then jumps to processing block 490, where buzz advertising information related to the buzz keywords is retrieved. In one embodiment, the web servers 102 communicate with the advertising servers 104 and transmit the retrieved buzz keywords to the advertising servers 104. Subsequently, the advertising servers 104 access the respective database 110 to retrieve buzz advertising information related to the buzz keywords.

Otherwise, if the user is registered with the entity 100, at processing block 460, a user profile is retrieved from the database 110. In one embodiment, the web servers 102 access the user tables 114 within the database 110 to retrieve the user profile and any other information pertaining to the user.

At processing block 470, buzz keywords corresponding to the user profile are selected. In one embodiment, the web servers 102 communicate with the buzz servers 106 and transmit the user profile to the buzz servers 106. The buzz servers 106 select the buzz keywords related to the user profile, such as, for example, buzz keywords related to the demographic, geographic, and/or behavioral profile of the user. The procedure then jumps to processing block 490, where buzz advertising information related to the selected buzz keywords is retrieved.

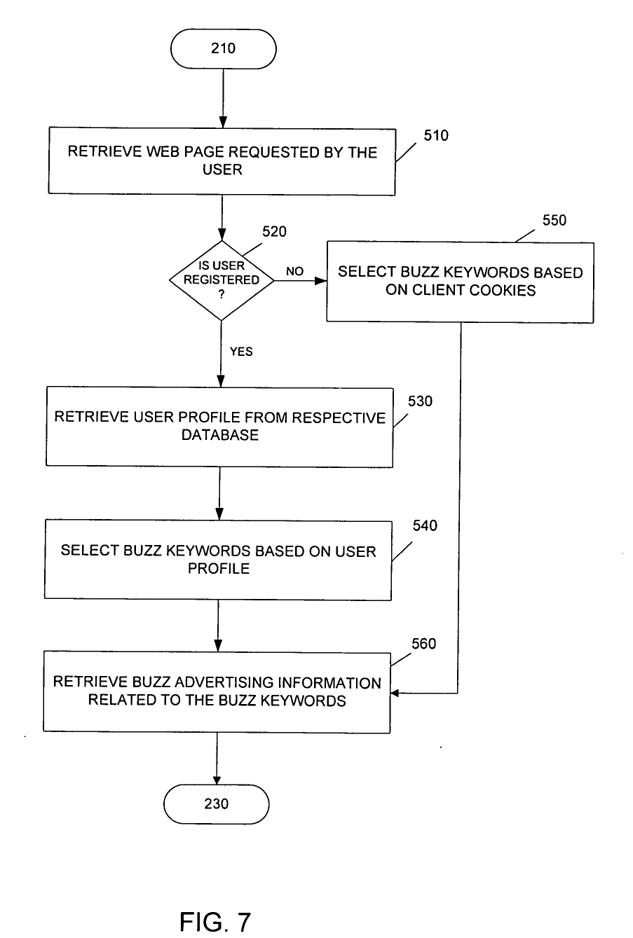

FIG. 7 is a flow diagram illustrating another alternate embodiment for the method to facilitate retrieval of the buzz advertising information. As shown in FIG. 7, subsequent to the receipt of the request for content information, at processing block 510, a web page requested by the user is retrieved. In one embodiment, the web servers 102 receive the request for content information from the user through the network 120 and retrieve a corresponding web page from the page tables 112 of the respective database 110 coupled to the web servers 102. In one embodiment, the requested web page is a generic page. The web servers 102 review the web page requested by the user to determine if the page refers to specific content material and belongs to a corresponding category stored in the page category tables 111 or if it is a content-generic web page.

At processing block 520, a decision is made whether the user requesting the retrieved page is registered with the entity 100. In one embodiment, the web servers 102 access the user tables 114 within the database 110 to determine whether the user tables 114 contain a record associated with the specific user or any other user information.

If the user is not registered with the entity 100, then at processing block 550, buzz keywords corresponding to user identification parameters, such as, for example, client cookies stored on the client machine 132, are retrieved. In one embodiment, the web servers 102 communicate with the buzz servers 106 and transmit one or more user identification parameters to the buzz servers 106, such as, for example, any client cookies residing on the client machine 132 or any other user identification information. The buzz servers 106 then access the corresponding buzz keyword tables 115 within the database 110 and retrieve buzz keywords related to the user identification parameters. The procedure then jumps to processing block 560, where buzz advertising information related to the buzz keywords is retrieved. In one embodiment, the web servers 102 communicate with the advertising servers 104 and transmit the retrieved buzz keywords to the advertising servers 104. Subsequently, the advertising servers 104 access the respective database 110 to retrieve buzz advertising information related to the buzz keywords.

Otherwise, if the user is registered with the entity 100, at processing block 530, a user profile is retrieved from the database 110. In one embodiment, the web servers 102 access the user tables 114 within the database 110 to retrieve the user profile and any other information pertaining to the user.

At processing block 540, buzz keywords corresponding to the user profile are retrieved. In one embodiment, the web servers 102 communicate with the buzz servers 106 and transmit the user profile to the buzz servers 106. The buzz servers 106 then access the corresponding buzz keyword tables 115 within the database 110 and retrieve buzz keywords related to the user profile, such as, for example, buzz keywords related to the demographic, geographic, and/or behavioral profile of the user. The procedure then jumps to processing block 560, where buzz advertising information related to the buzz keywords is retrieved.

Referring back to FIG. 1, in yet another embodiment, the entity 30 may enable advertising entities (not shown) to access the buzz data storage module 34 and to retrieve the current topics of interest as characterized by the buzz data stored within the buzz storage module 34. The advertising entities may subsequently target their advertisements based on the available buzz data. Alternatively, the advertising delivery platform 36 may transmit the current topics of interest to advertising entities for targeted placement of advertisements according to the corresponding buzz data.

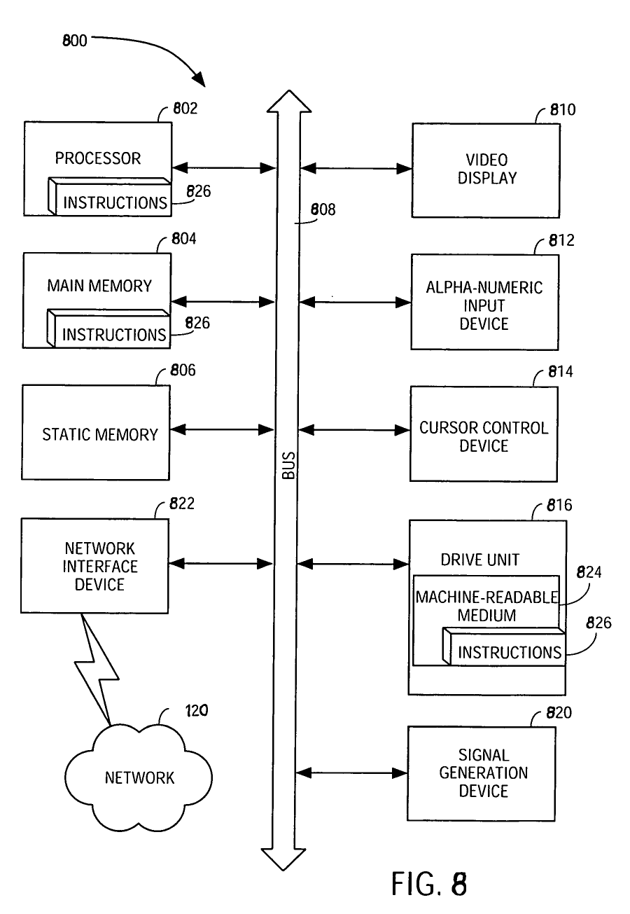

FIG. 8 shows a diagrammatic representation of a machine in the exemplary form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker), and a network interface device 820.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 820.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
receiving a request for content from a user over a network;
retrieving said content and buzz advertising information related to selected buzz data associated with said content and further related to said user, said buzz data corresponding to at least one relevant topic of user interest; and
displaying said content and said buzz advertising information for said user.

2. The method according to claim 1, wherein said request for content is a search query received from said user.

3. The method according to claim 2, wherein said retrieving further comprises:
retrieving query results related to said search query;
retrieving buzz keywords associated with query terms of said search query from said buzz data; and
retrieving said buzz advertising information related to said buzz keywords.

4. The method according to claim 3, further comprising:
forming a query comprising said retrieved buzz keywords; and
retrieving results for said formed query.

5. The method according to claim 4, wherein said displaying further comprises:
displaying said query results, said results for said formed query, and said buzz advertising information for said user.

6. The method according to claim 1, wherein said request for content is a request for a context-specific web page.

7. The method according to claim 6, wherein said retrieving further comprises:
retrieving said context-specific page;
retrieving a page category related to said context-specific page;
retrieving buzz keywords associated with said page category from said buzz data; and
retrieving said buzz advertising information related to said buzz keywords.

8. The method according to claim 7, wherein retrieving said buzz keywords further comprises:
retrieving a user profile corresponding to said user; and
selecting buzz keywords related to said user profile from said buzz keywords associated with said page category.

9. The method according to claim 1, wherein said retrieving further comprises:
retrieving said content related to said request; and
retrieving said buzz advertising information related to selected buzz data associated with a user profile of said user, said buzz advertising information being further targeted to said user based on at least one predetermined parameter associated with said user.

10. The method according to claim 1, further comprising enabling access to said buzz data to a plurality of advertising entities, said plurality of advertising entities to target advertisements to said user based on said available buzz data.

11. The method according to claim 1, further comprising transmitting said buzz data to a plurality of advertising entities, said plurality of advertising entities to target advertisements to said user based on said available buzz data.

12. The method according to claim 1, further comprising continuously storing and updating said buzz data in a buzz storage module at predetermined periods of time.

13. A system comprising:
at least one web processing server to receive a request for content from a user over a network and to retrieve said content for said user; and
at least one advertising server coupled to said at least one web processing server to retrieve buzz advertising information related to selected buzz data associated with said content and further related to said user, said buzz data corresponding to at least one relevant topic of user interest;
said at least one web processing server to display said content and said buzz advertising information for said user.

14. The system according to claim 13, wherein said request for content is a search query received from said user.

15. The system according to claim 14, further comprising:
at least one buzz server coupled to said at least one web processing server and said at least one advertising server, said at least one buzz server to retrieve buzz keywords associated with query terms of said search query from said buzz data;
said at least one web processing server to retrieve query results related to said search query; and
said at least one advertising server to retrieve said buzz advertising information related to said buzz keywords.

16. The system according to claim 15, wherein said at least one web processing server further forms a query comprising said retrieved buzz keywords and retrieves results for said formed query.

17. The system according to claim 16, wherein said at least one web processing server further displays said query results, said results for said formed query, and said buzz advertising information for said user.

18. The system according to claim 13, wherein said request for content is a request for a context-specific web page.

19. The system according to claim 18, further comprising:
at least one buzz server coupled to said at least one web processing server and said at least one advertising server;
said at least one web processing server to retrieve said context-specific page and a page category related to said context-specific page;
said at least one buzz server to retrieve buzz keywords associated with said page category from said buzz data; and
said at least one advertising server to retrieve said buzz advertising information related to said buzz keywords.

20. The system according to claim 19, wherein said at least one web processing server further retrieves a user profile corresponding to said user, and said at least one buzz server further selects buzz keywords related to said user profile from said buzz keywords associated with said page category.

21. The system according to claim 13, wherein said at least one web processing server further retrieves said content related to said request, and said at least one advertising server further retrieves said buzz advertising information related to selected buzz data associated with a user profile of said user, said buzz advertising information being further targeted to said user based on at least one predetermined parameter associated with said user.

22. A computer readable medium containing executable instructions, which, when executed in a processing system, cause said processing system to perform a method comprising:
receiving a request for content from a user over a network;
retrieving said content and buzz advertising information related to selected buzz data associated with said content and further related to said user, said buzz data corresponding to at least one relevant topic of user interest; and
displaying said content and said buzz advertising information for said user.

23. The computer readable medium according to claim 22, wherein said retrieving further comprises:
if said request for content is a search query, retrieving query results related to said search query;
retrieving buzz keywords associated with query terms of said search query from said buzz data; and
retrieving said buzz advertising information related to said buzz keywords.

24. The computer readable medium according to claim 22, wherein said retrieving further comprises:
if said content is a context-specific page, retrieving said context-specific page;
retrieving a page category related to said context-specific page;
retrieving buzz keywords associated with said page category from said buzz data; and
retrieving said buzz advertising information related to said buzz keywords.

25. The computer readable medium according to claim 24, wherein retrieving said buzz keywords further comprises:
retrieving a user profile corresponding to said user; and
selecting buzz keywords related to said user profile from said buzz keywords associated with said page category.

26. The computer readable medium according to claim 22, wherein said retrieving further comprises:
retrieving said content related to said request; and
retrieving said buzz advertising information related to selected buzz data associated with a user profile of said user, said buzz advertising information being further targeted to said user based on at least one predetermined parameter associated with said user.
